(19) United States
(12) Patent Application Publication
(10) Pub. No.: US 2008/0226876 A1
(43) Pub. Date: Sep. 18, 2008

(54) Method for Producing a Core Material Reinforcement for Sandwich Structures and Said Sanwich Structures

(75) Inventor: Matthias Alexander Roth, Griesheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: ROEHM GMBH, DARMSTADT (DE)

(21) Appl. No.: 11/914,064

(22) PCT Filed: Apr. 5, 2006
(86) PCT No.: PCT/EP06/03110

§ 371 Date: Nov. 9, 2007

(30) Foreign Application Priority Data
Jul. 27, 2005 (DE) 10-2005-035-681.8

(51) Int. Cl. B32B 3/00; B32B 38/04

(52) U.S. Cl. 428/172; 156/256

(57) ABSTRACT

A sandwich structure reinforcement carried out by a gripper, which pierces the sandwich structure or the core material, only at one side, thereby obtaining a hole penetrating through, e.g., a polymer rigid foam. At the opposite side, the gripper catches the reinforcing structure (for example a sewing thread, pultruded fiber-plastic composite rods) and inserts the reinforcing structure into the sandwich structure during back movement thereof. The through hole is additionally enlargeable by the reinforcing structure, thereby making it possible to obtain an important fiber volume part in the through hole of the core material.

### TECHNICAL FIELD OF THE INVENTION

The invention relates to the design and production of reinforcement elements that traverse the thickness of the core composite according to the preamble of claim 1 for strengthening core composite structures.

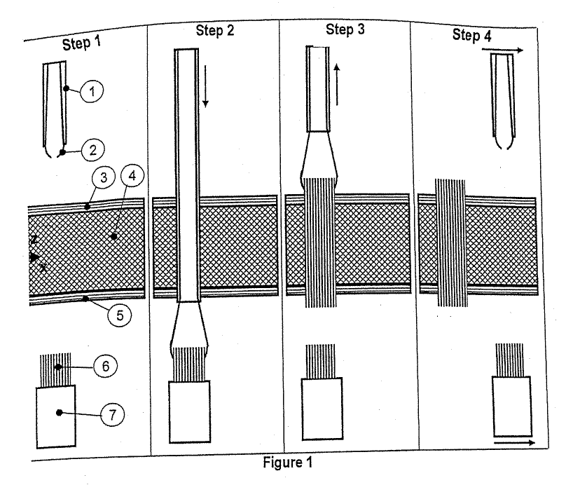

The invention is suitable for reinforcing core composite structures. The core composite structures may preferably comprise a fibre-plastic composite with cover layers of textile semifinished products (FIG. 1; 3 and 5, for example woven or laid fabrics, mats, etc.), a core material (FIG. 1; 4, for example polymeric foam) and a polymeric matrix material (thermoplastic or thermosetting material). Core composites are structures that are built up layer by layer and comprise relatively thin upper cover layers (FIG. 1; 3) and lower cover layers (FIG. 1; 5) and also a relatively thick core layer (FIG. 1; 4) of low apparent density.

With the aid of this invention, the transversal properties (for example compressive or tensile rigidity and strength in the z direction, shear rigidity and strength in the xz and yz planes, peel resistance between cover layer and core, failsafe behaviour) and also the in-plane mechanical properties of core composite structures (for example rigidity and strength in the direction of the plane of the sheet) can be increased significantly with the aid of reinforcement elements that traverse the thickness.

### PRIOR ART

All previously known production methods for reinforcing core composite structures in the direction of their thickness, such as for example the double-saddle-stitch, blind-stitch or two-needle stitching technique and the tufting method, have the common feature that the reinforcement elements (for example stitching threads, rovings) are introduced into the core composite structure together with the needle. In the case of conventional textile-like stitched materials, the penetration of the needle including the stitching thread and the subsequent pulling out of the stitching needle and leaving behind of the stitching thread in the stitching hole generally do not present any problem on account of the resilient effect of the textiles. However, in the case of core composite structures with a polymeric rigid foam as the core material, the penetration of the needle including the stitching thread causes the cellular structure to be destroyed and the polymeric rigid foam to be deformed to the size of the stitching needle diameter as a result of plastic and elastic deformation.

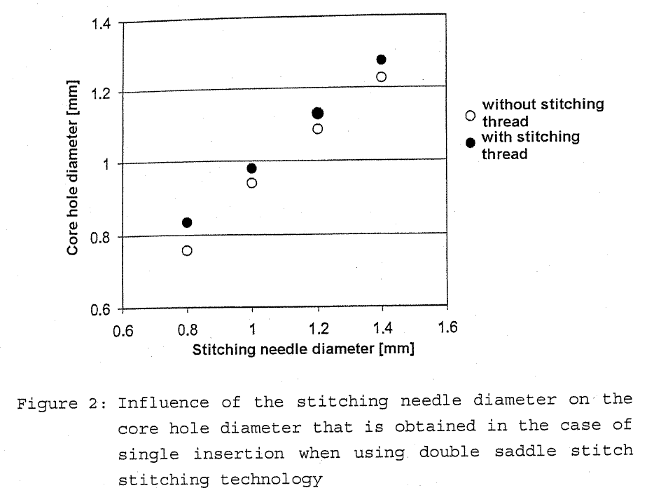

Once the stitching needle has been pulled out and the stitching thread left behind in the stitching hole, there is a reduction in the through-hole on account of the elastic deformation components of the cell walls, whereby the core hole diameter again becomes smaller again than the stitching needle diameter (see FIG. 2). There is a virtually linear dependence between the diameter of the through-hole in the core that is obtained and the stitching needle diameter that is used (FIG. 2), i.e. the greater the stitching needle diameter, the greater too the resultant through-hole in the core. Furthermore, the stitching thread causes additional widening of the core hole diameter. This additional widening corresponds approximately to the cross-sectional area of the stitching thread (FIG. 2). It is also the case here that, the greater the cross-sectional area of the stitching thread used, the greater the additional widening.

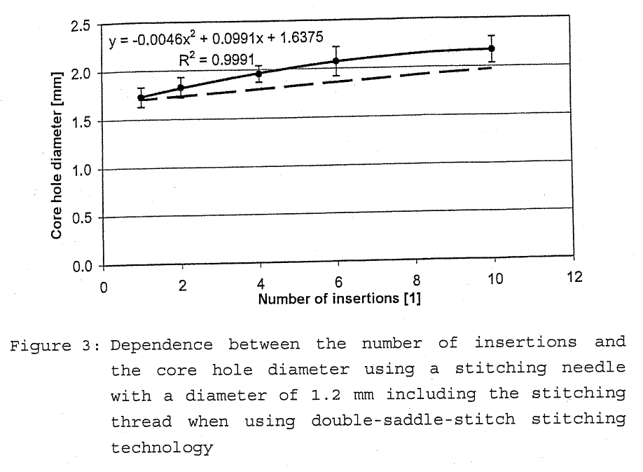

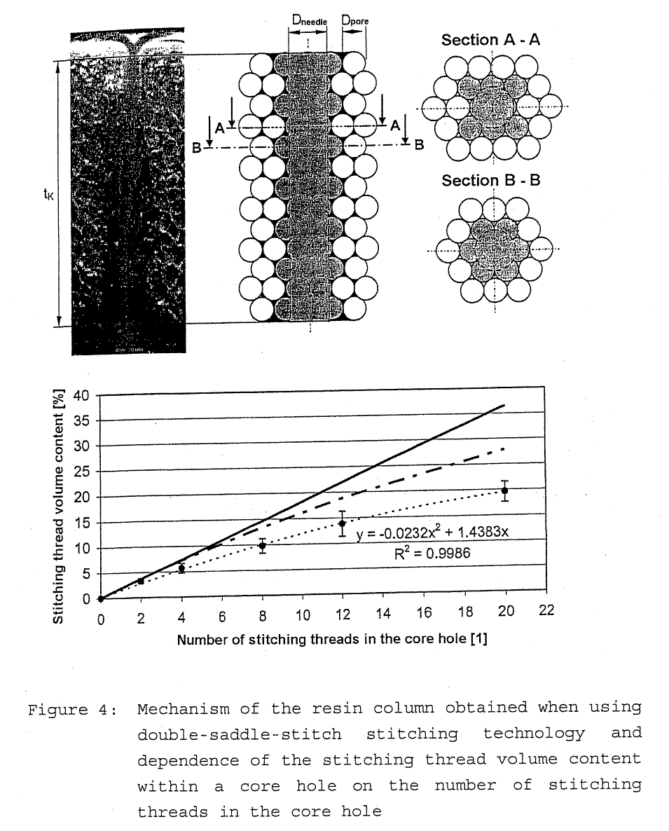

After impregnation of the core composite structure with the liquid matrix material and subsequent curing, the core hole diameter and the fibre volume content of the stitching thread in the core hole can be determined by means of microscopic examinations. Experimental examinations on core composite structures stitched by means of double-saddle-stitch stitching technology and when using a stitching needle with a diameter of 1.2 mm and an aramid thread with a line weight of 62 g/km show here that the diameter of the resin column obtained in the core material (about 1.7 mm) is greater than the determined core hole diameter of a non-impregnated core composite structure (about 1.1 mm; compare FIGS. 2 and 3) in the case of single insertion. The reason for this is that adjacent cell walls in the region of the stitching needle diameter are destroyed by the insertion of the stitching needle. In the subsequent infiltration process, resin can then penetrate into these then open pores with an average diameter of about 0.7 mm (FIG. 4).

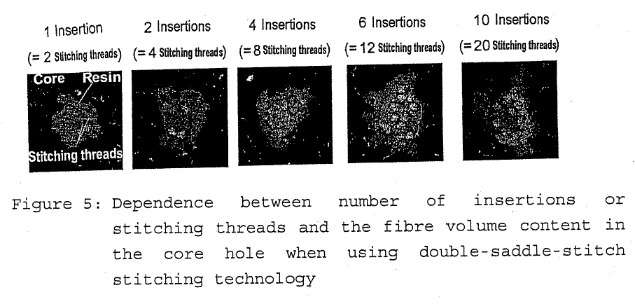

When the double-saddle-stitch stitching technique is used, with each insertion two stitching threads are always introduced in the z direction of the core composite structure (see FIGS. 4 and 5). In order to increase the stitching thread volume content within a through-hole, and consequently the reinforcing effect, already stitched places can be stitched once more or a number of times. However, stitching threads that are already in the core hole may be damaged by the renewed insertion of the stitching needle. With the aid of microscopic examinations, it can be established that the stitching thread volume content may not be increased in proportion to the number of insertions, as would be expected (FIGS. 3, 4 and 5). The reason for this is that the diameter of the core hole does not remain constant as the number of insertions and the stitching threads introduced increase, since the core hole diameter is increased by the additional introduction of stitching threads by approximately the cross-sectional area of the threads (FIG. 3, dashed curve). However, it is likewise established that the true curve profile (FIG. 3, solid curve) only obeys this theory when there is a very high number of insertions. By contrast, when there is a small number of insertions, the diameter of the core hole increases to a disproportionately great extent. The reason for this is the positioning accuracy of the stitching machine. If a position which is to be stitched once again is moved to again, the stitching needle is not inserted precisely centrally into the already existing hole but a little to the side, within the limits of positioning accuracy, whereby the core hole is increased disproportionately. After insertion into the same core hole approximately eight times, the said hole has already been widened to such an extent that the stitching needle enters the existing hole without additional destruction of cell walls. With further insertions, the widening only takes place as a result of the additional stitching threads that are introduced. In FIGS. 4 and 5 there is shown the possible increase in the stitching thread volume content as the number of stitching threads in the core hole increases. The black curve in FIG. 4 describes the proportional increase of the stitching thread volume content with a constant core hole diameter, the dash-dotted curve describes it on the basis of the aforementioned theory of exact positioning accuracy and the additional widening of the core hole diameter as a result of the stitching threads introduced and the dotted curve describes the true profile of the stitching thread volume content as the number of stitching threads or insertions increases. In the case of single insertion, only a fibre volume content of about 3.2% can be achieved, which can be increased only to about 20% by insertion up to 10 times (see FIGS. 4 and 5). By contrast, the fibre volume content of a single stitching thread strand is about 58% (see FIG. 4).

It is clear from these examinations that the diameter obtained in the polymer core material when using conventional production methods (for example double-saddle-stitch stitching technology) is mainly dependent on the stitching needle diameter used, the cross-sectional area of the stitching thread and the core diameter of the polymeric rigid foam used. Since in the case of all the previously known reinforcing methods stitching needles and stitching threads are inserted simultaneously into the core composite structure, there is always an unfavourable relationship between the cross-sectional area of reinforcement elements that is introduced and the size of the core hole diameter. High fibre volume content in the core hole diameter, similarly high to the fibre volume content of the cover layers (greater than 50%), consequently cannot be achieved with conventional reinforcing methods. Since, however, the mechanical properties are mainly influenced by the high-rigidity and high-strength reinforcement elements that are introduced, the aim must be to strive for a fibre volume content of the reinforcement in the core hole diameter that is as high as possible. Furthermore, the high resin component in the core hole diameter causes an increase in the weight, which in the aerospace sector in particular is not tolerated.

### OBJECT

The invention is based on the object of improving the mechanical properties of core composite structures by incorporating reinforcement elements in the direction of the thickness of the core composite structure (z direction), with the possibility of achieving a high fibre volume content of the reinforcement in the core hole diameter. Furthermore, the weight is not to be adversely influenced too much by the incorporation of the reinforcement elements in the core composite structure. This novel stitching technique may likewise be used for preforming and fastening additional structural components (for example stringers, frames etc.) to the core composite structure.

### SOLUTION

This object is achieved by the introduction of a necessary through-hole in the core material and the introduction of the reinforcing structure taking place at different times from each other, whereby the fibre volume content of the reinforcement in the core hole diameter can be adjusted by the cross-sectional area of the stitching thread that is used. FIG. 1 illustrates the basic invention and design of a core composite structure reinforced in such a way. A gripper system (2) makes a unilateral insertion from one side of the core composite structure (steps 1 and 2) into the core material (4) and optionally through the upper textile cover layer (3) and lower textile cover layer (5) (step 2) and, with the aid of a gripper (1), receives on the opposite side a reinforcing structure (6), for example stitching thread, pultruded fibre-plastic-reinforced bars, which are supplied by means of a device (7), (step 2), and introduces the reinforcing structure into the core composite structure during the backward movement (step 3). In the subsequent process step, the gripper system (2) moves upwards and draws the reinforcing structure into the core or into the core composite structure (step 3).

A polymeric rigid foam (for example PMI, PVC, PEI, PU etc.) may be used as the core material (4). The core material (4) may have a thickness of up to 150 mm, a width of about 1250 mm and a length of 2500 mm. The upper textile cover layer (3) and the lower textile cover layer (5) may be constructed identically or differently and consist of glass, carbon, aramid or other strengthening materials. The thickness of an individual textile cover layer ply may be identical or different and lie between 0.1 mm and 1.0 mm. Thermoplastic or thermosetting materials may be used as the polymeric matrix material.

The reinforcing structure (6) may comprise both textile strengthening structures (for example stitching threads, rovings) or elements in bar form (for example pins of unidirectional fibre-plastic composite, unreinforced plastic or metal etc.). Typical diameters of the reinforcing structure (6) may be 0.1 mm to 2.0 mm.

In the subsequent process step, the stitched material or the reinforcing unit is transported further to the next insertion position and the reinforcing process is then repeated there. In addition, the supplied reinforcing structure may be cut to length, so that there is no link from one insertion to the other. The cutting to length may be performed by all customary technical means, such as for example by mechanical cutting or flame cutting. The drawing-in of the reinforcing structure can cause additional widening of the core hole diameter obtained by the insertion of the gripper system, whereby a high fibre volume content can be realized. Since the reinforcement elements are introduced into the core composite structure or only into the core material by tension, there is very good alignment and no buckling of the strengthening structure. With the aid of this reinforcing method, the incorporated reinforcement elements may likewise have an angle other than 0° in relation to the z axis, for example +/−45°, under loading with purely transverse force.

The use of core composite structures that are strengthed in the direction of their thickness according to the invention can be used in the transport sector, such as for example in aerospace, motor vehicle and rail vehicle construction and in shipbuilding, but also in the sport and medical sectors as well as in the building trade.

After the reinforcing process, the core composite structure may be impregnated with a thermosetting or thermoplastic matrix material in a liquid-composite-moulding process.

### LIST OF DESIGNATIONS

| Number | Designation |
|---|---|
| 1 | gripper |
| 2 | gripper system |
| 3 | upper textile cover layer |
| 4 | core material |
| 5 | lower textile cover layer |
| 6 | reinforcing structure |
| 7 | device for supplying the reinforcement |
| | elements (6) |

1-9. (canceled)

10: A reinforcing process for a core composite, comprising:
a gripper system making an insertion from one side of a structure into a core material or into the core material with cover layers applied, on an opposite side gripping a reinforcing structure and, by a backward movement, introducing the reinforcing structure into the core material or into the core material with cover layers applied.

11: A reinforcing process for a core composite according to claim 10, wherein the reinforcing structure includes textile-like strengthening structures or elements in bar form.

12: A reinforcing process for a core composite according to claim 10, wherein the cover layers include textile semifinished products, the core material of polymeric, natural or textured core material, and wherein the cover layers, the core material and the reinforcement elements are embedded in a polymeric matrix material.

13: A reinforcing process for a core composite according to claim 10, wherein the reinforcing structure is not cut to length after introduction into the core material or into the core material with cover layers applied.

14. A reinforcing process for a core composite, according to claim 10, wherein the reinforcing structure is cut to length after introduction into the core material or into the core material with cover layers applied.

15: A core composite, obtainable by a method of claim 10.

16: Use of the core composite according to claim 15 for production of spacecraft, aircraft, sea and land craft, and rail vehicles.

17: Use of the core composite according to claim 15 for production of sports equipment.

18: Use of the core composite according to claim 15 for production of structural elements for interior, trade-fair, and exterior construction.
